(19) United States
(12) Patent Application Publication
(10) Pub. No.: US 2002/0124057 A1
(43) Pub. Date: Sep. 5, 2002

(54) Unified communications system

(76) Inventor: Diego Besprosvan, Haifa (IL)

Correspondence Address: William C. Milks, III, Russo & Hale LLP, 401 Florence Street, Palo Alto, CA, 94301, US

(21) Appl. No.: 09/799,847

(22) Filed: Mar. 5, 2001

(51) Int. Cl. G06F 15/16

(52) U.S. Cl. 709/219

(57) ABSTRACT

A unified communications system that promotes communications using an Internet protocol communications platform that receives telephone, fax, e-mail, and documentary information to aggregate that information for access at a single location by any of various devices controlled by a person to whom the communications are directed. The unified communications system employs an IMAP4 message store for e-mail, fax, voice mail, and document files and can access LDAP-compatible databases for user information (e.g., address books). Subscribers to a unified communications service powered by the unified communications system can access messages by telephone; through a standard Web browser; through a wireless device, leveraging WAP to read and reply to messages and SMS for notifications; and, additionally, via Internet phones and other Internet Access Devices (LADs). Users can also store and access files on network databases and folders via the Web browser interface.

### FIELD OF THE INVENTION

The present invention relates to telecommunications and, more particularly, to communication by telephone, facsimile, e-mail, document dissemination, and video. Specifically, one embodiment of the present invention provides a system to unify telecommunications effected by a variety of techniques. More specifically, a preferred embodiment of the present invention provides a unified communications system to integrate telephone, facsimile, and e-mail communications, as well as communications through document dissemination and video or other digital communication technique.

### BACKGROUND OF THE INVENTION

Various approaches are known for communicating information over distance using electrical or electromagnetic signals. Besides telegraph, one of the early communication techniques was telephone. Analog telephone technology was developed in the last quarter of the Nineteenth Century and, while the technology has been improved, the telephone remains in prevalent use today.

With the advent of radio in the first quarter of the Twentieth Century, telecommunications expanded so that communication of information was no longer restricted to transmission over a conductor. In recent years, there has been a significant growth in wireless telephony, and with the advent of the so-called cell phone, the use of wireless communication is commonplace.

As telephony has evolved, so too has the technology used to encode the information being communicated. Analog techniques such as amplitude modulation have yielded to digital techniques. Additionally, various encoding and compression techniques have been developed to reduce bandwidth requirements for transmission of digital information. As a result, the so-called fax machine has become commonplace during the last twenty years.

More recently, telephone answering machines and voice mail systems have been commercially introduced to capture incoming voice messages in analog form on an audiotape cassette, for example, or to store digitized voice messages in electronic memory.

With the ever-increasing use of the Internet, another avenue for communication of various types of information has become available. Digital voice can be transmitted according to a protocol known as VoIP, for example. Faxes can be created using a text entry device and sent to a fax machine. Text messages can be transmitted as so-called email. Documents can be converted to text messages or attached to e-mail messages and transmitted. Even video files can be transmitted over the Internet, and rudimentary video streaming occurs. Routing of communications over the Internet can be through a telephone system or a wireless system.

Unfortunately, while there are various techniques and infrastructures for communicating information, there is no unified messaging capability. Telephone messages or voice mail is retrieved from one device or location, faxes from another, e-mail and/or attached documents from another, and video from yet another. That is, there is no system for aggregating information from different sources (e.g., telephone, fax, e-mail/documents, video, on so on) within a single system for delivery to the person for whom the information is intended. This results in various inefficiencies and attendant costs associated with the time required to retrieve asynchronous communications and devices required to access the information. Consequently, traditional techniques for communicating information require that a recipient maintain sufficient diverse equipment (e.g., telephones, telephone answering machines or voice mail systems, fax machines, computer networks having Internet access, and so on) and constantly monitor the equipment for the receipt of communications. In some instances, that equipment, for example, a fax machine, cannot be monitored remotely. As a result, difficulty can be experienced in receiving communications.

It would therefore be desirable to effectively communicate with a person by any of various telecommunications techniques that are commercially available or become available in the future. It would also be desirable to enable the person to access a unified communications system to retrieve any type of asynchronous communication from a single access point to efficiently obtain the information. Additionally, it would be desirable to enable the person to whom the communications are directed to retrieve the communications using any of various commercially available devices such as a telephone, cell phone, and/or microprocessor-based device.

### SUMMARY OF THE INVENTION

The present invention addresses the aforementioned problems by providing a method and apparatus for communicating among persons effectively by employing a unified communications system for asynchronously received communications. One embodiment of the present invention provides a system that promotes communications using an Internet protocol communications platform that receives telephone, fax, e-mail and/or documentary, and video information to aggregate that information for access at a single location by any of various devices controlled by the person to whom the communications are directed.

One embodiment of the unified communications system in accordance with the present invention provides a platform for aggregating telecommunications from various sources including telephone, fax, and e-mail. Preferably, the platform also enables aggregation of documentary information, whether or not attached to e-mail, and video, as well as provides a platform for other types of digital information.

The unified communications system of the present invention is designed ground-up on the basis of Internet protocol and specifically designed as part of a next-generation public network infrastructure. The unified communications system employs an IMAP4 message store for e-mail, fax, voice mail, and document files and can access LDAP-compatible databases for user information (e.g., address books). Subscribers to a unified communications service powered by the unified communications system of the present invention can access messages by telephone; through a standard Web browser; through a wireless device, leveraging WAP to read and reply to messages and SMS for notifications; and, additionally, via Internet phones and other Internet Access Devices (IADs). Users can also store and access files on network databases and folders via the Web browser interface.

One embodiment of the unified communications system in accordance with the present invention comprises various system modules, including a Web application server. The Web application server preferably comprises an HTTP server, a servlet engine, and a Web access server. The unified communications system also includes a WAP application server. The WAP application server preferably comprises an HTTP server, a servlet engine, and a WAP access server. The unified communications system additionally includes a voice application server for SIP (session initiation protocol). The voice application server for SIP preferably comprises an SIP server and a voice access server. Further, the unified communications system includes a voice application server for PSTN. The voice application server for PSTN preferably comprises a PSTN server and a voice access server. Also, the unified communications system includes a provisioning application server. The provisioning application server preferably comprises an HTTP server, a servlet engine, and a provisioning server. The unified communications system additionally includes an SMTP gateway. The unified communications system further includes a message store. The message store preferably comprises an IMAP server, an SMTP server, a filter engine, and one or more message storage units. Finally, the unified communications system includes a user data store. The user data store preferably comprises an LDAP server and one or more data storage units.

The unified communications system in accordance with the present invention has a distributed architecture that is modular and highly scalable. Thus, the unified communications system enables customized configuration and implementation.

The capability of scaling the unified communications system of the present invention has significant advantages. The modular and flexible design of the unified communications system enables numerous deployment scenarios. System modules can be deployed at a central location or individually distributed; and the number of modules of the same type can vary to accommodate the system configuration requirements.

The method of the present invention enables aggregation of communications from various sources. Preferably, the method enables voice mail, e-mail, and fax communications to be aggregated. The method also enables other communications such as documents and video to be aggregated as well. The method preferably enables access to communications by telephone; through a standard Web browser; through a wireless device, leveraging WAP to read and reply to messages and SMS for notifications; and, additionally, via Internet phones and other Internet Access Devices (IADs). Users can also store and access files on network databases and folders via the Web browser interface. The method also provides a unique provisioning procedure for allocating system utilization.

The unified communications system in accordance with the present invention effectively aggregates communications from various sources created by various techniques and provides access to the entire collection of communications at a single point of access by any of various devices. No known messaging system enables voice mail, e-mail, and faxes to be aggregated for access. The unified communications system of the present invention not only enables single-point access to voice mail, e-mail, and fax communications, but also enables access to documents, video, and other forms of digital information, for example, MP3 files.

### BRIEF DESCRIPTION OF THE DRAWINGS

FIG. 1 illustrates a schematic of one embodiment of a unified communications system in accordance with the present invention.

FIG. 2 illustrates a schematic of connections to a voice application server included in the unified communications system shown in FIG. 1.

FIG. 3 illustrates a schematic of scaling voice application servers for SIP.

FIG. 4 illustrates a schematic of scaling a user data store using a master/slave configuration to enhance distribution and availability.

FIG. 5 illustrates a schematic of scaling a user data store using a host referral configuration.

FIG. 6 illustrates a schematic of a message store included in the unified communications system shown in FIG. 1.

FIG. 7 illustrates a schematic of a RAID5 implementation for the message store shown in FIG. 6.

FIG. 8 illustrates a schematic of a message store incorporating a media server for voice messages.

FIG. 9 illustrates a schematic of an implementation of the unified communications system shown in FIG. 1 running on a single host machine.

FIG. 10 illustrates a schematic of a distributed implementation of the unified communications system shown in FIG. 1.

### DETAILED DESCRIPTION OF THE PREFERRED EMBODIMENTS

According to the present invention and referring now to the figures, wherein like reference numerals identify like elements of the various embodiments of the invention, one can effectively receive telecommunications produced by a variety of techniques via an integrated communications platform. Additionally, one can access those communications by a variety of devices. One can also scale the communications platform as the need to aggregate increased message traffic increases.

One embodiment of the present invention provides an Internet protocol (IP) communications platform. The elements of the communications platform and their configuration and application within standard Internet and PSTN and VoIP and SIP network infrastructures will be described in detail below. The communications platform can be readily configured by system administrators and network managers, who have a general understanding of networks and communications hardware and software.

In general, the unified communications system in accordance with one embodiment of the present invention employs an IMAP4 message store for e-mail, fax, voice mail, and document files, and can access LDAP-compatible databases for user information (e.g., address books). Subscribers to the unified communications service powered by the unified communications system can access their messages by telephone; through a standard Web browser; through a wireless device, leveraging WAP to read and reply to messages, as well as SMS for notifications; and, lastly, via Internet phones and other Internet Access Devices (IADs). Users can also store and access files on network databases and folders via the Web browser interface.

The unified communications system of the present invention preferably has a distributed architecture that is modular and highly scalable, thereby enabling customized configuration and implementation. The system is designed ground-up on the basis of IP and specifically designed as part of a next-generation public network infrastructure. The modular and flexible design of the unified communications system allows for numerous deployment scenarios and enables scaling the system. System modules can be deployed at a central location or individually distributed. The number of modules of the same type can vary to accommodate the system configuration requirements.

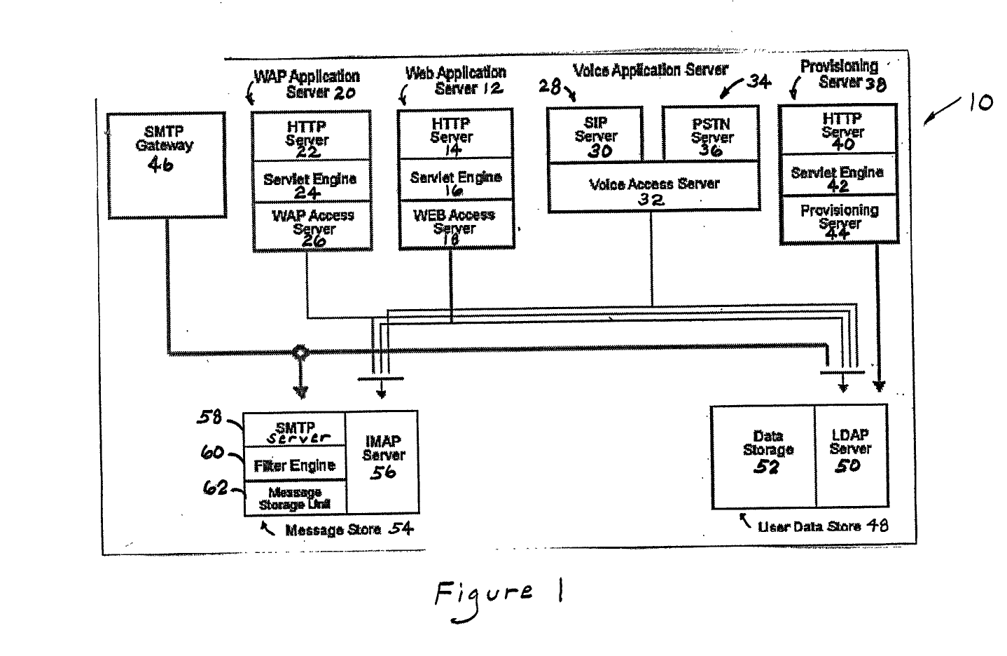

A preferred embodiment of the unified communications system in accordance with the present invention, generally indicated by the numeral 10, is shown in FIG. 1. FIG. 1 provides a system overview. FIG. 1 is a diagram that depicts the logical layout of the IP communications platform modules. The unified communications system 10 is comprised of several servers. For the sake of simplicity, each server will be described as a single server machine, although, in many cases, several servers may be installed on one machine.

As shown in FIG. 1, one embodiment of the unified communications system 10 in accordance with the present invention comprises various system modules, including a Web application server 12. The Web application server 12 preferably comprises an HTTP server 14, a servlet engine 16, and a Web access server 18. The Web application server 12 provides access to message requests from the Internet. The unified communications system 10 also includes a WAP application server 20. The WAP application server 20 preferably comprises an HTTP server 22, a servlet engine 24, and a WAP access server 26. The WAP application server 20 provides access to message requests from WAP cellular devices. The unified communications system 10 additionally includes a voice application server for SIP 28. The voice application server for SIP 28 preferably comprises an SIP server 30 and a voice access server 32. Further, the unified communications system 10 includes a voice application server for PSTN 34. The voice application server for PSTN 34 preferably comprises a PSTN server 36 and the voice access server 32. Also, the unified communications system 10 includes a provisioning application server 38. The provisioning application server 38 preferably comprises an HTTP server 40, a servlet engine 42, and a provisioning server 44. The unified communications system 10 additionally includes an SMTP gateway 46. The unified communications system 10 further includes a user data store 48. The user data store 48 preferably comprises an LDAP server 50 and one or more data storage units 52. Finally, the unified communications system 10 preferably includes a message store 54. The message store 54 preferably comprises an IMAP server 56, an SMTP server 58, a filter engine 60, and one or more message storage units 62. These elements will now be described in more detail.

As shown in FIG. 1, the Web application server 12 provides access to message requests from the Internet. The Web application server 12 is preferably comprised of three software components, namely, the HTTP server 14, the servlet engine 16, and the Web access server 18. The HTTP server 14 and servlet engine 16 (application server) are the application platform. The Web application server 12 is preferably based on Java servlet technology. The operating system for the Web application server 12 can be Unix, Linux, Solaris, Windows NT, Windows 2000, or any other operating system that supports Java version 1.1 or above.

There are various connectivity interfaces for the Web access server 18, as shown in FIG. 1. The Web access server 18 can be connected to by the Web client, for example, a personal computer (PC) or other microprocessor-based device, via the Internet. The Web access server 18 also connects to the message (IMAP4) store 54, as well as to the user data (LDAP) store 48.

The configuration of the unified communications system 10 enables scaling for Web access demand by one or more of the following approaches. Web access can be scaled to accommodate a growing number of users by upgrading the processor and/or providing additional memory for the Web application server 12. Web access capability can also be expanded by deploying additional Web application servers 12 with load balancing (DNS or hardware/software load balancing) at a central location. Alternatively, Web access capability can be expanded by employing a distributed architecture with Web application servers 12 deployed in different geographic locations together with distributed load balancing.

Referring again to FIG. 1, the WAP application server 20 provides access to message requests from WAP cellular devices. The WAP application server 20 is preferably comprised of three software components, namely, the HTTP server 22, the servlet engine 24, and the WAP access server 26. The HTTP server 22 and servlet engine 24 (application server) are the application platform. The WAP access server 26 is preferably based on Java servlet technology. The operating system for the WAP application server 20 can be Unix, Linux, Solaris, Windows NT, Windows 2000, or any other operating system that supports Java version 1.1 or above.

As shown in FIG. 1, there are various connectivity interfaces for the WAP access server 26. The WAP access server 26 connects to the WAP client (WAP device) via the Internet. The WAP access server 26 also connects to the message (IMAP4) store 54, as well as to the user data (LDAP) store 48.

The configuration of the unified communications system 10 enables scaling for WAP access demand by one or more of the following approaches. WAP access can be scaled to accommodate a growing number of users by upgrading the processor and/or providing additional memory for the WAP application server 20. WAP access capability can also be expanded by deploying additional WAP application servers 20 with load balancing (DNS or hardware/software load balancing) at a central location. Alternatively, WAP access capability can be expanded by employing a distributed architecture with WAP application servers 20 deployed in different geographic locations together with distributed load balancing.

The unified communications system 10 additionally includes a voice application server for both SIP 28 and PSTN 34. The voice application server for SIP 28 preferably comprises the SIP server 30 and the voice access server 32. The voice application server for PSTN 34 preferably comprises the PSTN server 36 and the voice access server 32.

The voice application server for SIP 28 and PSTN 34 incorporates software and hardware required for processing message requests from SIP devices or from standard telephones and faxes. Although the voice application server 28 is comprised of the SIP server 30, the PSTN server 36, and the voice access server 32, it is not mandatory that both the SIP and the PSTN servers reside on the same machine. The voice application server 28 can be configured to support either one or both (SIP and PSTN) applications according to user or customer requirements. The operating system for the voice application server 28 can be Unix, Linux, Solaris, Windows NT, Windows 2000, or any other operating system that supports Java version 1.1 or above.

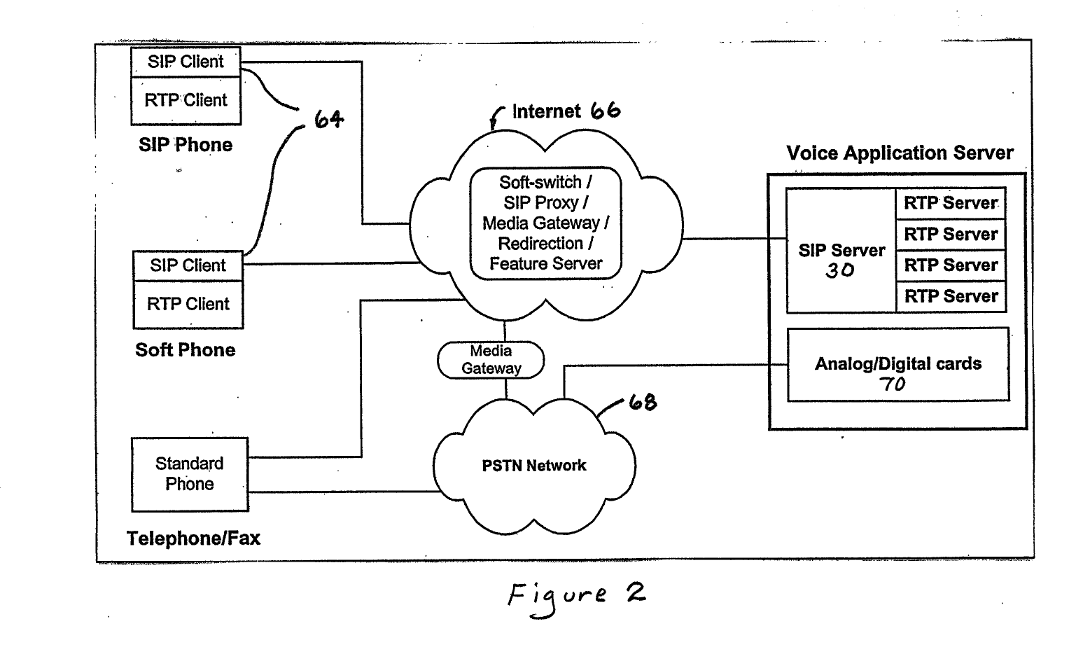

There are various connectivity interfaces for the SIP 30 and PSTN 36 servers. As shown in FIG. 2, the SIP server 30 connects to one or more SIP clients 64, an SIP gateway, soft-switch, SIP proxy servers, and/or other SIP devices on the Internet 66. The SIP server 30 also connects to the IMAP server, as shown in FIG. 1. Additionally, the SIP server 30 connects to the LDAP server 50.

As further shown in FIG. 2, the PSTN server 36 connects to a PSTN 68 via a standard analog card (e.g., a Dialogic or Brooktrout single channel card) or digital (T1/E1) card (e.g., Brooktrout or Cisco multiple channel card) 70. The PSTN server 36 also connects to the IMAP server 54, as shown in FIG. 1. Additionally, the PSTN server 30 connects to the LDAP server 50.

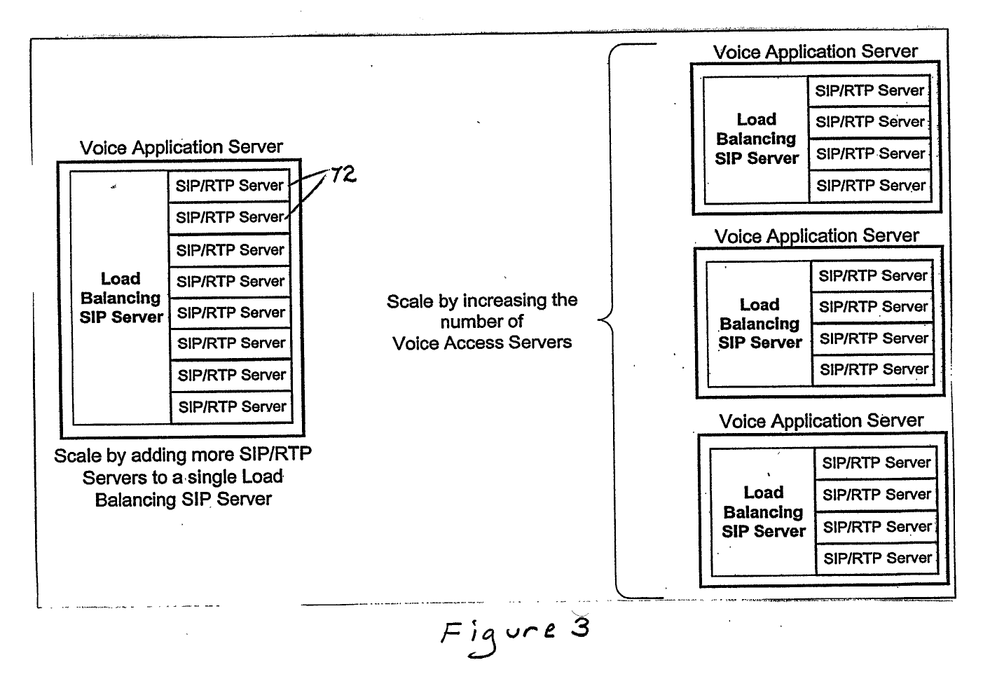

The configuration of the unified communications system 10 enables scaling of the voice application server 28, 34 access demand by one or more of the following approaches. As shown in FIG. 3, the voice application server for SIP 28 can be scaled to accommodate subscriber increase for local and/or geographic distribution as follows.

SIP access capability can be scaled to accommodate a growing number of users by deploying dedicated voice application servers for SIP 28 together with RTP servers 72 at a central location with load balancing (DNS or hardware/software load balancing). SIP access can also be expanded by employing a geographic distribution of dedicated voice application servers for SIP 28 together with distributed load balancing. Alternatively, SIP access can be scaled to accommodate a growing number of users by upgrading the processor and/or providing additional memory for the voice application server for SIP 28.

PSTN access can be scaled to accommodate a growing number of users by installing additional analog and/or digital cards 70 into the PSTN server 30. Alternatively, PSTN access can also be expanded by employing a geographic distribution of dedicated voice application servers for PSTN 34.

Referring again to FIG. 1, the unified communications system 10 includes a provisioning application server 38. The provisioning application server 38 is preferably comprised of three software components, namely, the HTTP server 40, the servlet engine 42, and the provisioning server 44. The provisioning server 44 incorporates all software required for system administration and management, including adding customers/users, attributing authorization privileges, and permitting customization. The provisioning server 44 enables changing, adding, and managing the data in the user data store 48. The operating system for the provisioning application server 38 can be Unix, Linux, Solaris, Windows NT, Windows 2000, or any other operating system that supports Java version 1.1 or above.

There are various connectivity interfaces for the provisioning application server 38, as shown in FIG. 1. The provisioning application server 38 connects to the Web client via the Internet. The provisioning application server 38 also connects to the LDAP server 50. The provisioning application server 38 operates as a front-end to the LDAP server 50.

The configuration of the unified communications system 10 enables scaling of the provisioning application server 38 access demand. The provisioning application server 38 can be scaled to accommodate a growing number of users by deploying additional provisioning application servers 38 with load balancing (DNS or hardware/software load balancing) at a central location.

As further shown in FIG. 1, the unified communications system 10 also includes the SMTP gateway 46. The SMTP gateway 46 relays standard Internet e-mail to the designated destination. The operating system for the SMTP gateway 46 can be Unix or Linux.

As shown in FIG. 1, there are various connectivity interfaces for the SMTP gateway 46. The SMTP gateway 46 connects to the local SMTP server 58 associated with the message store 54. The SMTP gateway 46 also connects to the LDAP server 50 for routing purposes.

The SMTP gateway 46 can be scaled to accommodate a growing number of users by upgrading the processor and/or providing additional memory. Alternatively, the SMTP gateway 46 can be expanded by adding machines with load balancing.

Referring to FIG. 1, the unified communications system 10 additionally includes the user data store 48. The data store 48 stores the user database. The user data store 48 is preferably comprised of the database (disk) 52 with the front-end LDAP server 50. The provisioning application server 38 manages the user data store 48. The operating system for the user data store 48 can be Unix, Linux, or Solaris.

As shown in FIG. 1, there are various connectivity interfaces for the user data store 48. The user data store 48 connects to the provisioning server 44. The user data store 48 also connects to all access servers and to the SMTP gateway 46, as well as to the message (IMAP4) store 54.

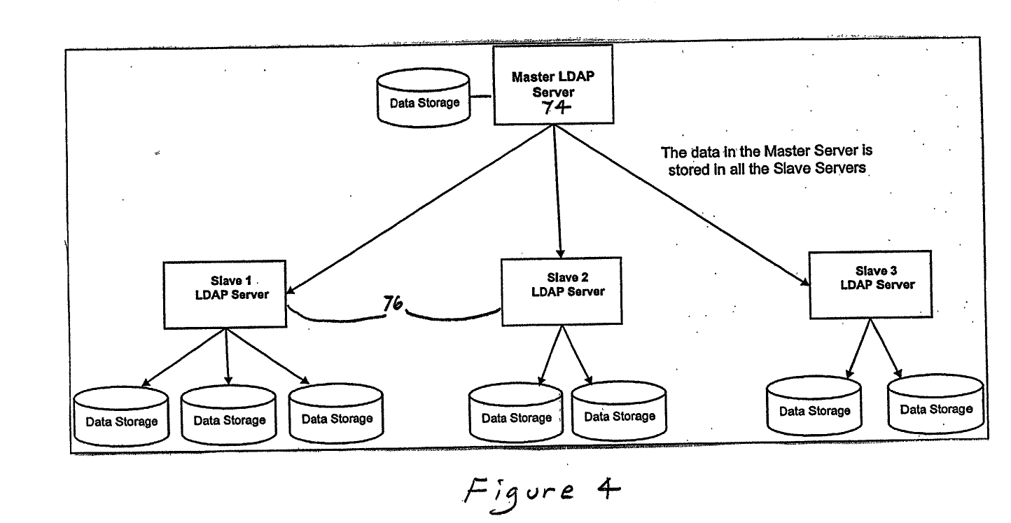

The configuration of the unified communications system 10 enables scaling and fault tolerance of the user data store 48 by one or more of the following approaches. As shown in FIG. 4, the user data store 48 can be scaled to accommodate a growing number of users or for efficient allocation of storage resources using a distribution and availability application for distributing multiple data stores by implementing a master/slave topology. A master server 74 relays all the data to a slave server 76. This ensures that data is always accessible. This configuration is used for data protection and storage backup.

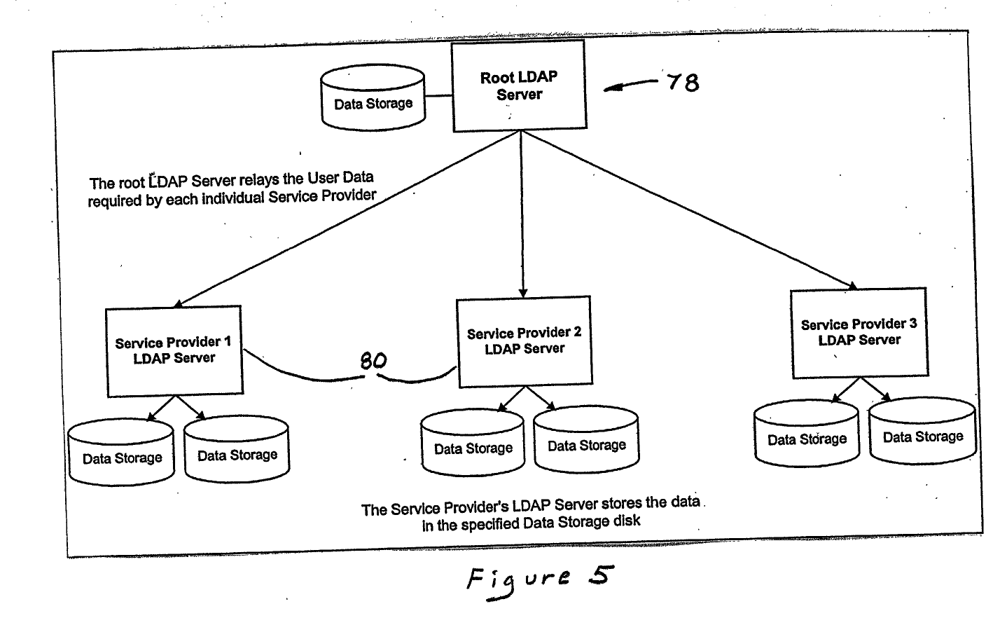

Alternatively, as shown in FIG. 5, the user data store 48 can be scaled to accommodate a growing number of users or for allocation of storage resources by a host referral application that provides reference/redirection. A root data store 78 refers the request to a secondary data store 80. For example, the root data store 78 located at the local hosting location relays only the data essential for a specific service provider or organization to the remote hosting location. The referral/routing tree describes the route taken to transfer specific data from the source storage unit to a predefined destination. This application is performed by implementing the LDAP directory information tree.

Alternatively, the user data store 48 can be scaled to accommodate a growing number of users by upgrading the processor and/or providing additional memory. Also, the user data store 48 can be scaled to accommodate a growing number of users by adding storage disks. Fault tolerance can be achieved through mirroring, that is, the user data store 48 (e.g., the root LDAP server and data storage 78) can be mirrored to a second user data store, thereby providing a redundant, fault tolerant system in case of disk failure.

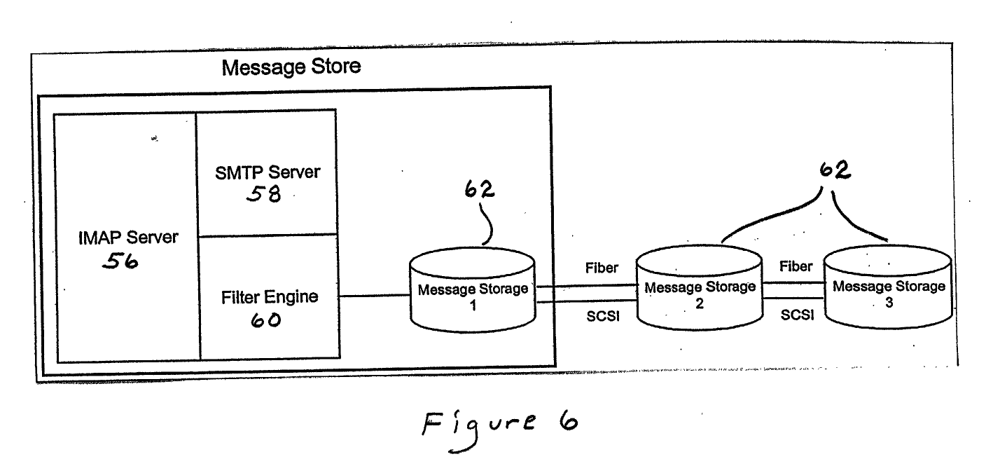

Referring again to FIG. 1, the unified communications system 10 includes the message store 54. The message store 54 is the device used to store messages and files. The message store 54 stores and maintains all messages (e.g., e-mail, voice mail, faxes, and data files). In one embodiment, the message store 54 comprises the front-end IMAP server 56, the SMTP server 58, the filter engine 60, and one or more message storage units 62, as shown in FIG. 6. The IMAP server 56 controls and manages the message database 62. The filter engine 60 enables users to define filtering parameters (i.e., redirect, reject, forward, reply, and/or filter incoming e-mail to various folders). The operating system for the message store 54 can be Unix, Linux, or Solaris.

As shown in FIG. 1, there are various connectivity interfaces for the message store 54. The message store 54 connects to all access servers and to the SMTP gateway 46. The message store 54 also connects to LDAP server 50.

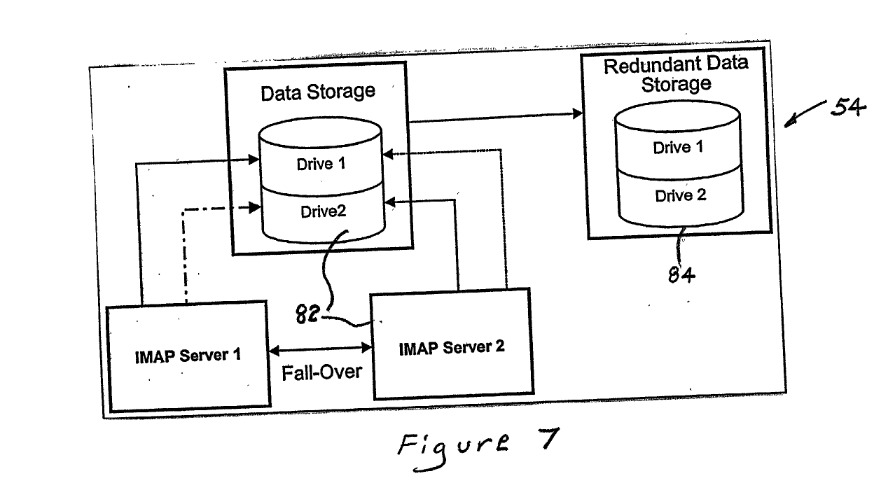

There are various approaches to scaling and fault tolerance for the message store 54. As shown in FIG. 7, the message store 54 can be scaled to accommodate a growing number of users by installing additional message store systems 82 (e.g., RAID5 or NetApp).

Considered in more detail, FIG. 7 shows an exemplary implementation of a RAID5 message store 54. In the example, the RAID5 array system provides improved I/O performance for a large number of users by spreading the load across several drives. Each server controls a specific drive. In case of server failure (fail-over), the second server seizes control of the failed server's drive. The addition of a redundant data storage system 84 for mirroring the disk contents creates a complete fault-tolerant system. The message store 54 can be scaled to accommodate a growing number of users by linking message store modules.

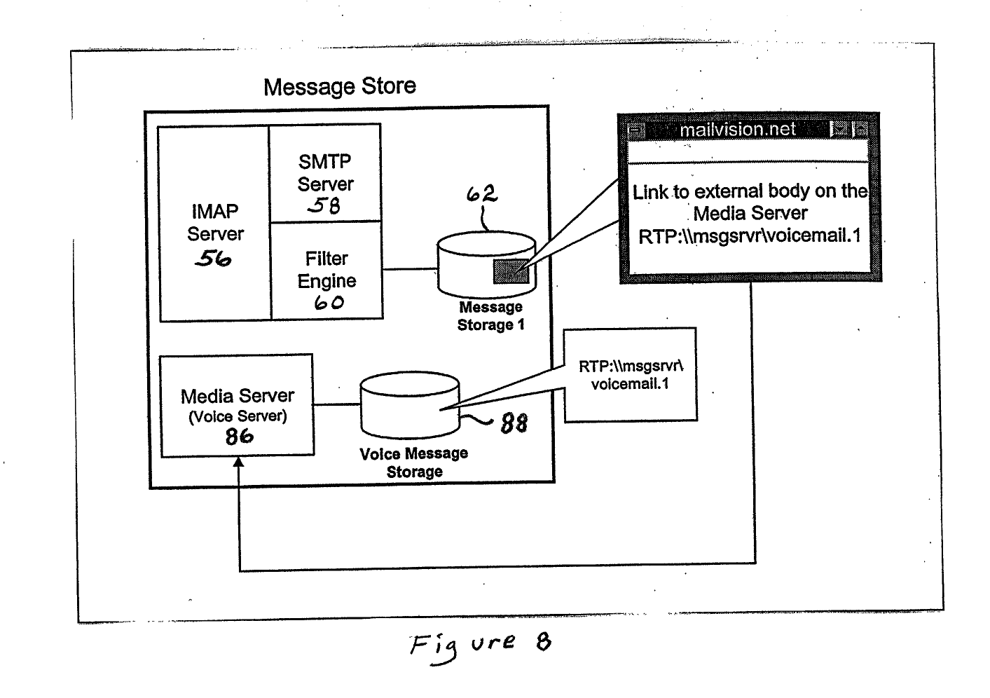

Referring to FIG. 8, in some cases the IMAP server 56 may not be capable of efficient processing of voice messages. By adding a media server 86 (RTP server), voice messages can be stored in a separate message store 88 (i.e., a message store for voice messages). The IMAP server 56 stores the pointer (URL) to the voice message in the media store 88.

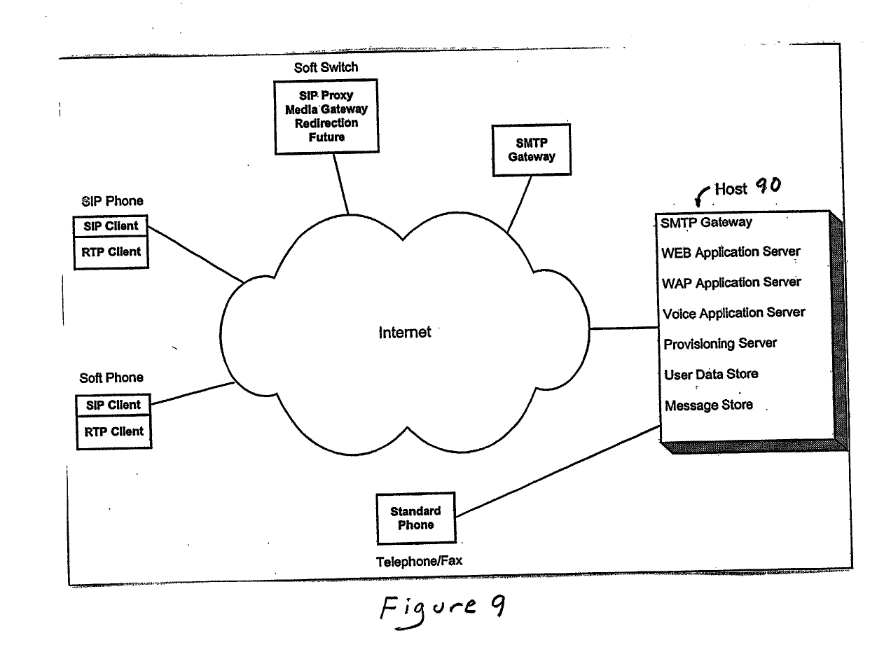

As described above, the architecture of the unified communications system 10 in accordance with the present invention supports various scaling configurations. As shown in FIG. 9, in a basic application, all servers and applications can be installed on a single host machine 90.

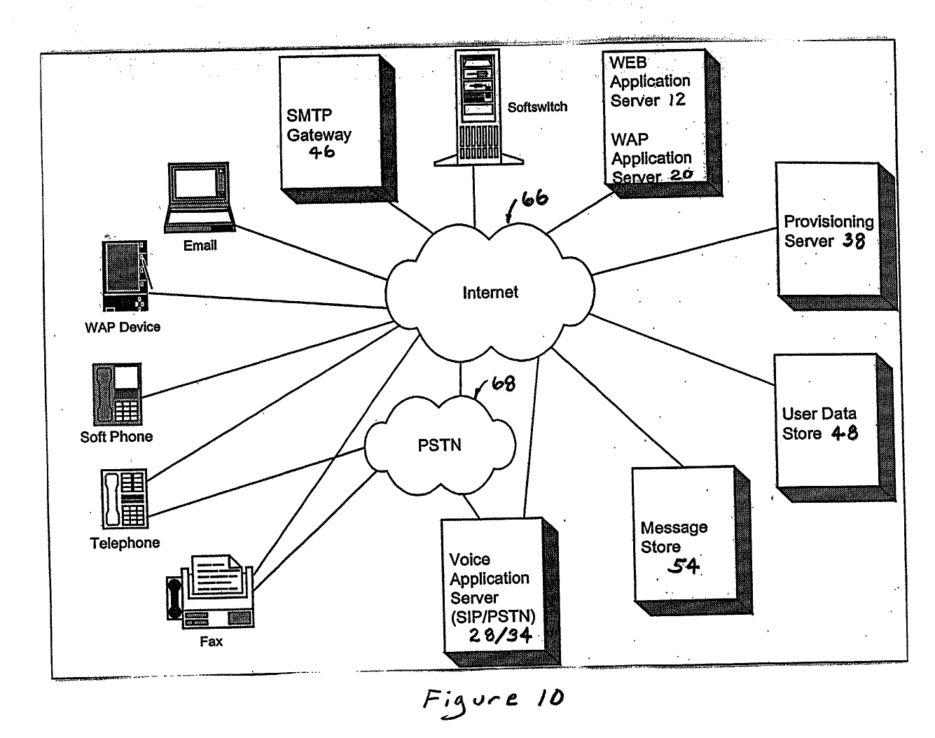

Alternatively, as shown in FIG. 10, in a distributed configuration, the application servers of the unified communications system 10 are installed on separate machines. Communications devices access the appropriate servers through the Internet or PSTN.

The distributed architecture of the unified communications system 10 of the present invention is modular and highly scalable allowing for custom-configured implementation. The unified communications system 10 includes the IMAP4 message store 54 for e-mail, fax, voice mail, and document files and can access LDAP-compatible databases 48 for user information (e.g., address books).

The operation of the unified communications system 10 in accordance with the present invention, that provides an IP communications platform, will now be described. Subscribers to a unified communications service powered by the unified communications system 10 can access messages by telephone; through a standard Web browser; through a wireless device, leveraging WAP to read and reply to messages and SMS for notifications; and, additionally, via Internet phones and other Internet Access Devices (IADs). Users can also store and access files on network databases and folders via the Web browser interface.

The user and interface features will now be described in detail. As described above, the message media include e-mail, voice mail, fax, and documents. The message media can additionally include video and other digital data. In the description that follows, the operational features are organized by access medium. These access media include phone, for example, standard and cellular; Internet, for example, a standard Web browser, standard e-mail client (e.g., MS Outlook), IP phone (SIP compatible); and wireless device, for example, a WAP phone.

The unified communications system 10 enables Web browser access. The IP communications platform is designed to run in a standard Internet messaging environment using Internet Explorer version 4.0 and up or Netscape version 4.0 and up. In general, the operation relating to Web browser access is as follows.

The first operational feature relating to Web browser access is “message listing.” Voice messages are filtered to the virtual voice folder. Fax messages are filtered to the virtual fax folder. E-mail messages are filtered to the virtual e-mail folder. Messages are stored in standard e-mail format, for example, RFC822 and MIME.

The second operational feature relating to Web browser access is “inbox message listing details.” The details for a listed inbox message include an icon identifier. The message icon identifies the message type as a voice message, fax, or e-mail message. The details for the listed inbox message also include a sender field that identifies sender information. The details for the listed inbox message additionally include a subject field, for example, voice message, fax header information, or e-mail message subject text. The details for the listed inbox message further include the date that the message was sent. Finally, the details for the listed inbox message provide the size or time (i.e., length) of the message. For e-mail messages, the size of the message in kb is indicated; for faxes, the size in pages is indicated; and for voice messages, the time length in minutes and seconds is indicated.

The third operational feature relating to Web browser access is “play/view.” In the case of a voice message, a Java applet enables the user to listen to the message in streaming audio. For example, the voice message can be played with standard WAV players. In the case of a fax message, a Java applet (7 kb) enables the user to view fax pages. Faxes can also preferably be viewed using a standard TIFF viewer. Faxes can be saved as .tif files. In the case of an e-mail message, the message is viewed by the user using a standard Web browser.

The fourth operational feature relating to Web browser access is “record/compose.” In the case of a voice message, a voice player plug-in enables the user to record a message. Voice player buttons preferably include “start,” “pause,” and “stop.” The user is preferably able to review the recorded message. In the case of faxes and e-mail messages, the user is preferably able to compose a message in standard e-mail format. The unified communications system 10 also supports file attachments to fax and e-mail messages.

The fifth operational feature relating to Web browser access is “add attachments.” The user is able to add attachments to a message either from the local drive or from the “MyFiles” document folder.

The sixth operational feature relating to Web browser access is “spell check.” A Java applet preferably enables the user to spell check text contained in messages.

The seventh operational feature relating to Web browser access is “send/forward.” In the case of a voice message, the user is able to send or forward a voice message to other e-mail addresses. Preferably, the user can use the address book to address the message to one or more e-mail addresses. In the case of fax or e-mail messages, the user is able to send or forward a message or file to other fax or e-mail addresses. Preferably, the user can use the address book to address the message to one or more fax and/or e-mail addresses.

The eighth operational feature relating to Web browser access is “reply.” The user is able to open the compose dialog with the sender's details in the “To:” field. Also, the user can choose to display the original message. If the original message was a voice message, a pointer to the voice message is provided.

The ninth operational feature relating to Web browser access is “save draft.” The user is able to save the message in the “Drafts” folder in order to continue to compose at a later time.

The tenth operational feature relating to Web browser access is a “MyFiles document folder.” The user is able to store any type of file in the “MyFiles” document folder. The user can access files from anywhere at anytime. The user is able to forward accessed files to another e-mail account.

The eleventh operational feature relating to Web browser access is “save attachment on disk.” Voice mail can be stored by the user as a standard .wav file on a local store (e.g., a PC hard drive). Fax messages can be stored by the user as standard .tif files on the local store. E-mail attachments and documents can be saved to the local store as well.

Web browser access also enables the user to access an address book. The first operational feature relating to Web browser access respecting the address book is that the address book lists are preferably composed of any combination of e-mail and subscriber fax entries. The address book enables the user to address a message to multiple recipients and different media devices (e.g., fax, e-mail, or voice mail). The address book also enables the user to store additional personal information relating to recipients. The address book can be accessed from any Web browser or by telephone.

The second operational feature relating to Web browser access respecting the address book is “import.” The user is able to import the address book from MS Outlook or Netscape Messenger.

The third operational feature relating to Web browser access respecting the address book is “add, edit, and delete contacts.” The user is able to add new contacts and edit and/or delete existing contacts in the address book.

The fourth operational feature relating to Web browser access respecting the address book is “sort.” The user is able to sort a contact list.

The fifth operational feature relating to Web browser access respecting the address book is “compose.” The user is able to address a message directly from the address book. The compose dialog opens with the addressee in the recipient line. The user can select “To:”, “CC:”, or “BC:”.

The sixth operational feature relating to Web browser access respecting the address book is “group lists.” The user is able to create group distribution lists. Group lists allow for message distribution to selected fax and/or e-mail entries in the group.

Web browser access also enables the user to manipulate messages. The first operational feature relating to Web browser access respecting message manipulation is “delete.” The user is able to delete any message or document.

The second feature relating to Web browser access respecting message manipulation is “move.” The user is able to move one or more messages to another folder.

The third operational feature relating to Web browser access respecting message manipulation is “sort.” The user is able to sort messages by type, sender, subject, or date. The user is also able to display only messages that contain specific character sequences in the sender string or subject field, for example, all messages that contain the character string JOHN.

Web browser access also enables the user to access external accounts. The user can access POP3 or IMAP4 accounts. The user is able to setup, view, and process e-mail messages from POP3 and/or IMAP4 e-mail accounts.

The unified communications system 10 additionally provides various user administration features in connection with Web browser access. The following features and functions are configured using a Web Browser.

Web browser access enables the user to specify various user-defined parameters. The first operational feature relating to Web browser access respecting user-defined parameters is specifying “personal details.” The user is able to edit user name, first name, last name, telephone number, and e-mail address.

The second operational feature relating to Web browser access respecting user-defined parameters is setting “user preferences.” The user is able to define the number of messages per folder page. The user is also able to create a personal signature for e-mail and faxes sent from the Web browser. Additionally, the user is able to display e-mail from specified external accounts. Further, the user can change the password for higher security access.

The third operational feature relating to Web browser access respecting user-defined parameters is “message folders and organization.” The unified communications system 10 preferably provides system folders, including “Inbox”, “Sent Messages”, “Draft Messages”, “Trash”, and “MyFiles” folders. The “Inbox” folder can be sorted into virtual e-mail, voice, and fax folders or custom-defined folders. E-mail sent from a standard email client is deposited in a “Sent Items” folder. The unified communications system 10 also enables the user to create user-defined folders that are personal folders. Messages can be sorted in the folders by sender, subject, date, and size, with the sort ascending or displayed in accordance with messages sent by a specified sender or subject.

Web browser access also enables the user to specify various delivery filters. The delivery filters allow filtering and redirection of messages to various user folders. In one embodiment, there are four filters. The first filter is a “reject filter.” The reject filter enables the user to define conditions for blocking messages. The second filter is a “redirect filter.” The redirect filter enables the user to redirect a message to a specific folder other than the inbox. The third filter is a “forward filter.” The forward filter enables the user to open a message into a “forward compose” dialog. The original message is attached to the new message. The fourth filter is a “reply filter.” The reply filter enables the user to open a message to a “reply compose” dialog. The “To:” field displays the originator's address.

In addition to Web browser access, the unified communications system 10 enables phone access. Phone access enables a user to access his or her account using any standard or cellular phone. In general, the operation relating to phone access is as follows.

The first operational feature relating to phone access is “message listing.” Inbox messages are played first-in, first-out. New messages are listed first, according to date and time of receipt. Messages remain new until they are opened. There is no regard to message type (voice, fax, or e-mail). The remaining messages are listed by date and time. The IVR reads the message's sender, subject, and date/time. The user can choose to listen to the message or continue to the next message.

The second operational feature relating to phone access is “play messages.” In the case of a voice message, the user can listen to the voice message. In the case of a fax message, the user can listen to the fax message header (fax message notification). In the case of an e-mail message, text-to-speech technology enables the user to listen to e-mail over the phone. Consequently, e-mail is preferably treated as standard voice mail.

The third operational feature relating to phone access is “record.” The user is able to record a message.

The fourth operational feature relating to phone access is “reply to e-mail.” The user is able to reply by voice mail to e-mail or voice messages.

The fifth operational feature relating to phone access is “send/forward.” The user is able to send or forward a message or document from the “My Files” folder. The user can use the address book to address the message to an e-mail account or fax number. The address book is preferably the same address book as described above in connection Web browser access.

Phone access also enables the user to manipulate messages. One operational feature relating to phone access respecting message manipulation is “delete.” The user is able to delete any message or document.

Phone access also enables the user to access the address book. The first operational feature relating to phone access respecting the address book is “compose.” The user is able to address a message directly from the address book.

The second operational feature relating to phone access respecting the address book is “group lists.” Group lists allow for message distribution to selected e-mail and/or fax entries in the group.

In addition to Web browser and phone access, the unified communications system 10 enables wireless access, for example, based on WAP. Wireless access enables a user to access his or her account using a WAP device. In general, the operation relating to wireless access is as follows.

The first operational feature relating to wireless access is “message listing.” Inbox message subject lines are displayed in the user interface.

The second operational feature relating to wireless access is “inbox message listing details.” The details for a listed inbox message include an icon identifier. The message icon identifies the message type as a voice message, fax, or e-mail message. The details for the listed inbox message also include a sender field that identifies sender information. The details for the listed inbox message additionally include a subject field, for example, voice message, fax header information, or e-mail message subject text. The details for the listed inbox message further include the date that the message was sent. Finally, the details for the listed inbox message provide the size or time (i.e., length) of the message. For e-mail and fax messages, the size of the message in kb is indicated. For voice messages, the time length in minutes and seconds is indicated.

Wireless access also enables the user to compose messages. The first operational feature relating to wireless access respecting message composition is “view message.” In the case of voice and fax messages, the user is able to display new message notifications. In the case of an e-mail message, the user is able to read the e-mail message.

The second operational feature relating to wireless access respecting message composition is “compose and send a message.” The user is able to compose and send a text message to an e-mail or fax number. The user can use the address book to address the message to an e-mail account or fax number. The address book is preferably the same address book as described above in connection Web browser access.

The third operational feature relating to wireless access respecting message composition is “forward a document from the ‘MyFiles’ document folder.” The user is able to forward a document to an e-mail or fax number. The user can use the address book to address the message to an e-mail account or fax number. The address book is preferably the same address book as described above in connection Web browser access.

The unified communications system 10 additionally provides various provisioning features. The following provisioning features and functions relate to user administration.

The first operational feature relating to provisioning respecting user administration is “user information.” A user name is provided by the user upon registration. The user name is not editable after registration is complete. The user name is comprised of 1-25 alphanumeric, case-sensitive characters (a-z, A-Z, and 0-9). The first character in the user name must be a letter. A password is also provided by the user upon registration. The password is editable. The password is comprised of 1-20 alphanumeric, case-sensitive characters (a-z, A-Z, and 0-9). A “forgot password” function enables the user to enter a personal question and answer to be activated in case the user forgets his or her password. The user also provides personal details upon registration. The personal details include first and last names, address, telephone number, and alternative e-mail address. A PIN number is also provided by the user upon registration. The PIN number is editable and is comprised of four digits (0-9). A “greeting” function enables the user to record a personal voice greeting up to 30 seconds in length, for example. A “signature” function enables the user to create a personal signature for e-mail and faxes sent from a Web browser.

The second operational feature relating to provisioning respecting user administration is “message and document folders.” As described earlier, the system folders include “Inbox”, “Sent Messages”, “Draft Messages”, “Trash”, and “My Files” folders. The user can also define folders, which are personal folders created by the user. The inbox can be sorted into virtual e-mail, voice, and fax folders or user-defined virtual folders.

The third operational feature relating to provisioning respecting user administration is “language.” The user is able to define the language for the following features: IVR voice prompts; text-to-speech, for example, reading a fax message header and e-mail messages over the phone; and Web interface.

Provisioning also enables the user to access the address book. The first operational feature relating to provisioning respecting the address book is “address book manipulation.” The user is able to add, edit, and delete contact details for fax, e-mail, and other personal information. The user is also able to add, edit, and delete group lists. The user is further able to address a message to multiple recipients and media devices for fax, e-mail, and voice mail. The address book can be accessed from any Web browser or telephone.

The second feature relating to provisioning respecting the address book is “import.” The user is able to import the address book from MS Outlook or Netscape Messenger. Files must be .cvs (comma value separated) and CDIFF format.

Provisioning also enables the user to manipulate messages. The first operational feature relating to provisioning respecting message manipulation is “delete and send to trash.” The user is able to delete a message or document. The message or document remains in the trash until the user deletes it from the “Trash” folder.

The second operational feature relating to provisioning respecting message manipulation is “delete from storage.” The user is able to delete the message or document directly from the storage. It is not stored in the “Trash” folder.

The third operational feature relating to provisioning respecting message manipulation is “sort.” The user is able to sort by sender, subject, date, and size, with the sort ascending or displayed in accordance with messages sent by a specified sender or subject. The user is able to display only messages that contain specific character sequences in the sender string or subject field, for example, to display messages that contain the character string JOHN in the sender field.

The fourth operational feature relating to provisioning respecting message manipulation is “play voice message by phone.” The user is able to select the order in which the inbox messages are played, for example, in the order new, old, and played. In this regard, new messages are messages that arrived since the last time that the user entered the system. Old messages are unplayed messages that arrived prior to the last time that the user entered the system. Finally, played messages are all played or read messages in the inbox.

Provisioning also enables the user to access external accounts. The user is able to setup, view, and process e-mail messages from personal POP3 and/or IMAP4 e-mail accounts.

The first operational feature relating to provisioning respecting external accounts is “add and edit external account.” The user is able to add more POP3 and/or IMAP4 e-mail accounts. The following parameters are required: account user name, password, host name (e-mail server), e-mail server type, outgoing mail server, and e-mail address.

The second operational feature relating to provisioning respecting external accounts is “personal signature.” The user is able to create a personal signature. This signature is active when the user accesses the compose dialog while displaying his or her external account or when replying or forwarding a message received from the external account.

The third operational feature relating to provisioning respecting external accounts is “delete external account.” The user is able to remove an external account from the system.

Provisioning also enables the user to specify various filters. In one embodiment, there are four filters. The first filter is a “reject filter.” The reject filter enables the user to define conditions for blocking messages. The second filter is a “redirect filter.” The redirect filter enables the user to redirect an incoming message to a specific folder other than the “Inbox” folder. The third filter is a “forward filter.” The forward filter enables the user to forward a message or document without opening it. The original message is attached to the new message. The user can forward using any media including fax, pager, e-mail, SMS, IP voice, voice, or other voice mail linked to a message. The fourth filter is “reply.” The reply filter enables the user to reply to a message without opening it. The original message is attached to the new message.

Provisioning also enables the user to define virtual folders. The unified communications system 10 provides “Inbox” folders. The messages in the inbox are filtered into three virtual folders: e-mail, voice, and fax. One operational feature relating to provisioning respecting user-defined folders enables the user to filter inbox messages into a user-defined virtual folder according to a set of specified criteria, for example, icon identifier, sender, subject, folder name, or other virtual folder.

The unified communications system 10 additionally provides various system administration features. The following system administration features and functions relate to system administration respecting user attributes assigned by a system administrator.

The first operational feature relating to system administration respecting user attributes assigned by a system administrator is “define data quota.” The system administrator is able to define the size of the user account in kb.

The second operational feature relating to system administration respecting user attributes assigned by a system administrator is “define access time.” The system administrator is able to define the time in the day that the user can obtain services.

The third operational feature relating to system administration respecting user attributes assigned by a system administrator is “access mode options.” The system administrator is able to authorize access to the unified communications system 10 via the following access media: device type (WAP, Web browser, or telephone) and IP address.

The fourth operational feature relating to system administration respecting user attributes assigned by a system administrator is “phone access options.” The system administrator can enable the user to record a personal greeting or to use a default greeting. The system administrator can also define the length of the voice message. The system administrator can additionally define the length of a voice reply. The system administrator can further obtain a local access number or an extension from the main number. Also, the system administrator can send faxes or forward calls to a local, long distance, or international telephone number. Additionally, the system administrator can limit the number of calls, voice messages, and fax pages.

The fifth operational feature relating to system administration respecting user attributes assigned by a system administrator is “define service types.” The system administrator is able to define services available to the user, for example, voice, fax, TTS, WAP, Web, “MyFiles”, follow me, and forward.

The following system administration features and functions relate to system administration respecting system attributes assigned by a system administrator. The first operational feature relating to system administration respecting system attributes assigned by a system administrator is “groups.” The system administrator is able to define user groups, company groups, and other administration groups. Different services can be assigned to each group. The system administrator can define access privileges to groups via IP address, host, Web, local access, and remote access.

The second operational feature relating to system administration respecting system attributes assigned by a system administrator is “logs.” The system administrator is able to log communications according to access media, for example, Web, voice, WAP, fax, and CDRs.

The third operational feature relating to system administration respecting system attributes assigned by a system administrator is “company default.” The system administrator cam define user preference, system configuration, voice capacity, Web capacity per server, company greeting, and language (e.g., for prompts, TTS, and Web interface).

The fourth operational feature relating to system administration respecting system attributes assigned by a system administrator is “welcome notification.” The system administrator is able to send a welcome note to new users via e-mail, fax, and/or voice.

The fifth operational feature relating to system administration respecting system attributes assigned by a system administrator is “message alerts.” The system administrator is able to forward to pager, telephone, SMS, e-mail, or fax.

The sixth operational feature relating to system administration respecting system attributes assigned by a system administrator is “IVR.” The system administrator is able to define auto-play variables for the IVR greeting. Variables may include company name, user group name, business hours, good morning/afternoon/evening, holiday/vacation greeting, and others. The greetings are allocated to companies, user groups, and individual users.

Finally, the unified communications system 10 additionally provides various root administration features. The following root administration features and functions relate to root administration.

The first operational feature relating to root administration is “system access provisioning.” An information technology manager can create and define new services, company groups, companies, and/or user groups. The information technology manager is able to access the unified communications system 10 to authorize access according to types of privileges of each type of services, group, and company.

The second operational feature relating to root administration is “password.” The information technology manager is able to assign a unique password to each system administrator.

The unified communications system 10 in accordance with the present invention effectively aggregates communications from various sources created by various techniques and provides access to the entire collection of communications at a single point of access by any of various devices. Unlike known messaging systems, the unified communications system 10 enables voice mail, e-mail, and faxes to be aggregated for access. The unified communications system of the present invention not only enables single-point access to voice mail, e-mail, and fax communications, but also enables access to documents, video, and other forms of digital information, for example, MP3 files.

Although the present invention has been described with a particular degree of specificity with reference to various embodiments, it should be understood that numerous changes both in the form and steps disclosed can be made without departing from the spirit of the invention. The scope of protection sought is to be limited only by the scope of the appended claims that are intended to suitably cover the invention.

I claim:

1. A unified communications system that promotes communications using an Internet protocol communications platform that receives at least voice, fax, and e-mail information to aggregate that information for access at a single location by any of various devices controlled by a person to whom the communications are directed, the system comprising:
a Web application server;
a voice application server for SIP;
a provisioning application server;
an outgoing mail gateway;
a message store; and
a user data store.

2. The system of claim 1 wherein the Web application server comprises an HTTP server, a servlet engine, and a Web access server.

3. The system of claim 1, further comprising a WAP application server.

4. The system of claim 3 wherein the WAP application server comprises an HTTP server, a servlet engine, and a WAP access server.

5. The system of claim 1 wherein the voice application server for SIP comprises an SIP server and a voice access server.

6. The system of claim 1, further comprising a voice application server for PSTN.

7. The system of claim 6 wherein the voice application server for PSTN comprises a PSTN server and a voice access server.

8. The system of claim 1 wherein the provisioning application server comprises an HTTP server, a servlet engine, and a provisioning server.

9. The system of claim 1 wherein the outgoing mail gateway is an SMTP gateway.

10. The system of claim 1 wherein the message store comprises an IMAP server, an SMTP server, a filter engine, and one or more message storage units.

11. The system of claim 1 wherein the user data store comprises an LDAP server and one or more data storage units.

12. The system of claim 1 wherein the system has a distributed architecture that is modular and highly scalable.

13. The system of claim 1 wherein the system enables customized configuration and implementation.

14. The system of claim 12 wherein the modular design of the system enables numerous deployment scenarios.

15. The system of claim 14 wherein the system modules are deployed at a central location.

16. The system of claim 14 wherein the system modules are individually distributed.

17. The system of claim 15 wherein the number of modules of the same type can vary to accommodate the system configuration requirements.

18. The system of claim 16 wherein the number of modules of the same type can vary to accommodate the system configuration requirements.

19. The system of claim 1 wherein the system additionally receives documentary information.

20. A unified communications system that promotes communications using an Internet protocol communications platform that receives at least voice, fax, and e-mail information to aggregate that information for access at a single location by any of various devices controlled by a person to whom the communications are directed, the system comprising:
a Web application server;
a voice application server for PSTN,
a provisioning application server;
an outgoing mail gateway;
a message store; and

21. a user data store.
